(19) United States
(12) Patent Application Publication
(10) Pub. No.: US 2025/0156944 A1
(43) Pub. Date: May 15, 2025

(54) SYSTEMS AND METHODS FOR ARTIFICIAL INTELLIGENCE (AI)-BASED REAL-TIME MANAGEMENT AND CONTROL OF USER ELECTRONIC ASSETS

(71) Applicant: iBUSINESS FUNDING LLC, Flor Lauderdale, FL (US)

(72) Inventor: Justin LEVY, Fort Lauderdale, FL (US)

(21) Appl. No.: 18/817,332

(22) Filed: Aug. 28, 2024

Related U.S. Application Data
(63) Continuation-in-part of application No. 18/389,126, filed on Nov. 13, 2023.

(51) Int. Cl. G06Q 40/03

(52) U.S. Cl. CPC G06Q 40/03; G06Q 2220/00

(57) ABSTRACT

Disclosed are systems and methods for a decision intelligence (DI)-based, computerized framework that executes artificial intelligence/machine learning (AI/ML) and/or large language model (LLM) software for performing real-time digital asset processing related to the control, management and transfer of such digital assets. The disclosed framework operates by computationally analyzing data related to users respective to requests for a digital asset transfer, which is effectuated via the AI/ML and/or LLM software, such that remittance, denials and/or curated ownership transfers of such assets can be securely performed in real-time.

### CROSS-REFERENCE TO RELATED APPLICATIONS

This application is a continuation-in-part (CIP), and claims the benefit of priority from U.S. patent application Ser. No. 18/389,126, filed Nov. 13, 2023, which is incorporated herein by reference in its entirety.

### FIELD OF THE DISCLOSURE

The present disclosure relates to secure digital control and management of digital assets, and more particularly, to a decision intelligence (DI)-based computerized framework for executing end-to-end (E2E) software that performs real-time digital asset processing.

### SUMMARY

Digital assets (or electronic assets, or assets, used interchangeably) for loan applications correspond to electronic and/or online resources that may be required as part of and/or leverage for a loan application. Such assets can aid lenders assessing a person's financial stability, creditworthiness and/or ability to repay the loan. According to some embodiments, specific types of digital assets may vary depending on a type of loan, the lender's requirements and/or the personal financial situation of the user (and/or other users in a geographic area). Accordingly, digital assets, as discussed herein, can refer to data structures, files and/or other forms of electronic or digital information that can be created, secured (e.g., encrypted, for example), downloaded, shared, modified, analyzed, and the like, or some combination thereof.

According to some embodiments, assets can include, but are not limited to, bank statements, pay stubs or employment documents, tax returns, credit reports, digital copies of identification, property appraisals, insurance policies, business financials, investment and/or retirement account statements, digital signatures, and the like, or some combination thereof. In some embodiments, such assets can correspond to fiat currency and/or cryptocurrency. Accordingly, such assets can correspond to data about a person (referred to as user data), which upon performance of curated predictive analysis techniques, as discussed herein, can effectuate the control and management of loans respective to requesting persons.

As such, according to some embodiments, the disclosed systems and methods discussed herein provide a novel, computerized framework that electronically collects user data related to a user's loan application, and via DI-based analysis, effectuates computerized mechanisms to remit, deny or curate loan application results that can securely facilitate digital or electronic forms for users to secure the electronic assets desired.

According to some embodiments, a method is disclosed for executing a DI-based framework that executes software that performs real-time digital asset processing. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for DI-based real-time digital asset processing.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### BRIEF DESCRIPTION OF THE DRAWINGS

The features and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure.

FIG. 1A illustrates a network diagram of a non-limiting system according to some embodiments of the present disclosure;

FIG. 1B illustrates a network diagram of a non-limiting system according to some embodiments of the present disclosure;

FIG. 2 illustrates a network diagram of a non-limiting system according to some embodiments of the present disclosure;

FIG. 3A illustrates a flowchart according to some embodiments of the present disclosure;

FIG. 3B illustrates a flowchart according to some embodiments of the present disclosure;

FIG. 4 illustrates an exemplary embodiment of the deployment of a a DI-based prediction model according to some embodiments of the present disclosure; and

FIG. 5 illustrates a block diagram showing an example of a computing device used in various embodiments of the present disclosure

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ different architectures or may be compliant or compatible with different protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4th or 5th generation (2G, 3G, 4G or 5G) cellular technology, mobile edge computing (MEC), Bluetooth, 802.11b/a/g/n/ac/ax/be, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, person, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

Certain embodiments and principles will be discussed in more detail with reference to the figures. According to some embodiments, the present disclosure provides systems and methods for a DI-based framework that can perform automated loan processing/approval based on users′-related data. As discussed herein, a user should be understood to be a user or entity, and for purposes of this disclosure will be referenced as a “user” without limiting the scope, as understood by those of ordinary skill in the art. As discussed below, the disclosed DI framework can implement any type of known or to be known artificial intelligence and/or machine learning (AI/ML) algorithms, techniques, models, and the like.

Accordingly, in some embodiments, the disclosed framework can implement and/or execute a large language model (LLM). The latest transformer-based LLMs have, among other features and capabilities, theory of mind, abilities to reason, abilities to make a list of tasks, abilities to plan and react to changes (via reviewing their own previous decisions), abilities to understand multiple data sources (and types of data-multimodal), abilities to have conversations with humans in natural language, abilities to adjust, abilities to interact with and/or control application program interfaces (APIs), abilities to remember information long term, abilities to use tools (e.g., read user/borrow data, compile and determine features/factors, command other systems, search for data, and the like), abilities to use other LLM and other types of AI/ML (e.g., neural networks, for example), ability to talk to other systems and/or platforms, abilities to improve itself, abilities to correct mistakes and learn using reflection, and the like.

Thus, as provided herein, the disclosed integration of such AI/ML and/or LLM technology can provide an improved loan-processing framework that can accurately, efficiently and securely determine loan application statuses, and leverage such real-time decisions to manage and control the transfer, ownership and structuring of digital asset assignments and availability.

According to some embodiments, the disclosed framework can operate overcomes the limitations of existing loan processing methods by employing fine-tuned models (e.g., DI-based models, including, but not limited to, AI/ML and/or LLMs, for example) derived from pre-trained language models to extract and process the user's interview information, irrespective of data format, style, or data type. By leveraging the capabilities of the pre-trained language models and lending models, the disclosed approach offers a significant improvement over existing solutions discussed above in the background section.

In some embodiments of the present disclosure, the disclosed framework provides for an AI/ML-generated loan approval parameters based on analysis of a user's-related data. In some embodiments, an automated decision/approval model may be generated to provide for lending recommendation parameters associated with the user. The automated decision/approval model may use historical users' data collected at the current lending facility location (i.e., a bank or lending institution entity) and at lending facilities of the same type located within a certain range from the current location or even located globally. The relevant users' data may include data related to other users having the same parameters such as age, financial conditions, language or locations, etc. The relevant users' data may indicate successfully approved loans and indication of a loan processor (i.e., a loan officer, a lending specialist, or an underwriter) who processed the loan applications for the users of the same parameters and the lending institution where the loan processing and underwriting was performed. This way, as evidenced from the disclosure herein, the best matching loan processing practitioner may be directed to respond to a given users application based on current user-related data and historical data of servicing users having the same characteristics such as age, language, financial condition, location, etc.

In some embodiments, the AI/ML technology may be combined with a blockchain technology for secure use of the user-related data and user-related interview or questionary data. In some embodiments, the lender or loan processing entities may be connected to the lending server (DS) node over a blockchain network to achieve a consensus prior to executing a transaction to release the loan approval/disapproval verdict and/or lending recommendation for the user based on the lending parameters produced by the AI/ML module. The system may utilize user's and/or user-related data assets based on the user entity and the lender entities being on-boarded to the system via a blockchain network.

The disclosed process according to some embodiments may, advantageously, eliminate the need for the lending practitioners to manually and, often times, inaccurately, analyze the user-related data using additional processing of user's documents and/or transcripts. Instead, via the executing of the disclosed framework, the loan approval/disapproval verdict and lending recommendations may be produced directly on a granular level based on the user and user-associated digital data according to the DI-based predictive analysis and lending recommendations, which in some embodiments, can be effectuated via the LLMs (and inherent natural language processing NLP), as discussed herein.

According to some embodiments, such process includes transparent lending recommendations/verdict mechanism that may be coupled with a secure communications chat channel (implemented over a blockchain network) which supports both parties to set and agree on the loan processing and terms with each other. In some embodiments, the chat channel may be implemented using a chat Bot (e.g., LLM).

Accordingly, as discussed herein, the disclosed framework can process loan applications via (recursively) trained, compiled and executed AI/ML and/or LLM models, which can be performed via the following automatically operated steps:

A user applies online through a digital intake form provided by a user entity implemented on PC, notebook, tablet or mobile device. The user's data is generated from supplied data fields. Then, additional user-related documents are added to the user's data including but not limited to driver's license, tax returns, business profit and loss statements, and balance sheet over the last two years.

In some embodiments, the framework may perform optical character recognition (OCR) on all (or at least a portion) of the electronic documents and categorize, correctly label them and identify what they are. The framework may then use an AI/ML model to check the documents against other documents that have been received from other approved users with similar parameters such as age, location, language, financial conditions, etc. The model can be trained over many different data points to detect similarities and also differences between the applying user and approved users. The model hosted on a device (e.g., a lender server, network node, client device, and/or some combination thereof, as discussed herein) r may then categorize the similarities and differences and may provide feedback to the user in an automated fashion. The feedback may indicate some missing data or documents or may indicate a probability of getting the loan application approved.

In some embodiments, user calls may be recorded, transcribed and processed by an AI-based chat bot configured to answer questions and also give feedback and relay the feedback from the lending server to the users in an automated fashion. The responses may be based on other users in similar situations across similar industries with similar requests and similar loan types.

In some embodiments, the lending server may receive additional user data (i.e., financial details) and may auto input the financial details into an underwriting calculator and create a credit memo (e.g., electronic document). In some embodiments, the interactions between underwriters and sales professionals may be complied into a large training set of data. Then, the lending server may create the questions from underwriting and submit them to sales or the user directly depending on the lead source (if there is a sales person to them, if direct lead then directly to the user). The user or the sales rep will then have an opportunity to automatically and digitally supply the answers to those questions which will then inform the system and complete the credit memo.

The credit memo once completed goes to an underwriter for review. However, the disclosed embodiment employs the ML module to scan the credit memo using the derived key features and output lending recommendations containing questions and comments that may be relayed to sales or the user directly in an automated fashion depending on the lead source.

Once addition user-related data comes back, the credit memo is modified and sent for approval. Once approved, a commitment letter is automatically compiled using the ML module based on most common conditions for loans that are most similar to the one that is being processed. This may be manually checked (optionally) before is officially sent out to the user or to a sales rep.

In some embodiments, the lending server may derive key elements from the credit memo and may display them in a Hypertext Markup Language (e.g., HTML5)-rendered video that displays the specific loan criteria to the users walking them through the credit memo and all the pertinent information. At the end of the video, the user is provided a link to full commitment letter in DocuSign format.

A closing checklist may be auto-generated based on the most common closing items based on a set that is most common to similar loans in the training data set. This may be manually reviewed by a closer (optionally), enhanced and then digitally sent out. As documents are uploaded to the system, they may be automatically OCRed and confirmed for completeness. In some embodiments, the documents and transactions may be recorded on a private blockchain ledger. The documents may be stored in a form of uniquely minted NFTs.

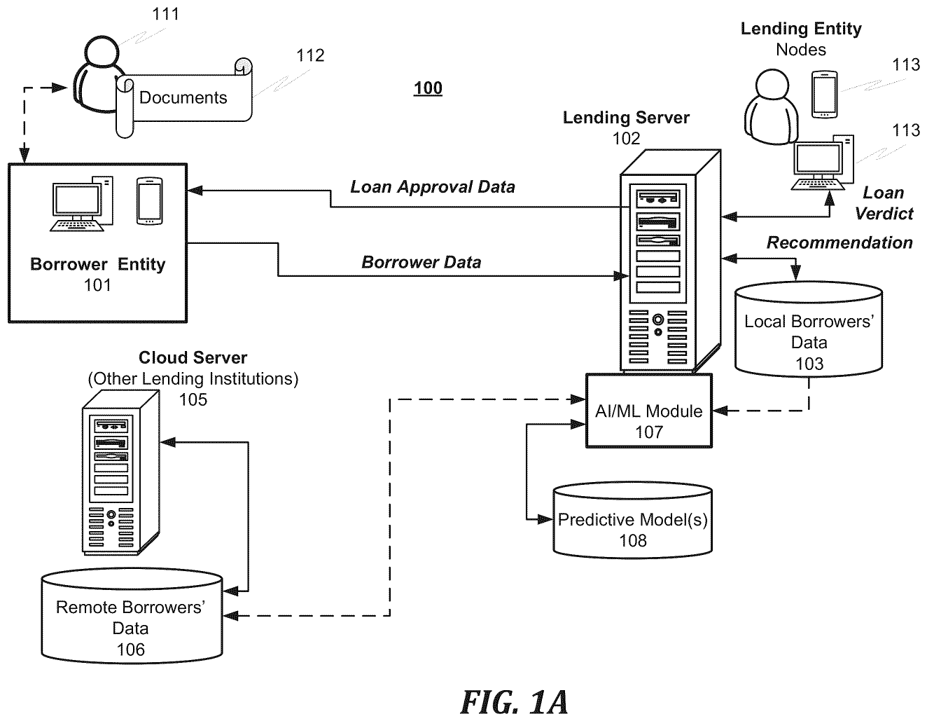

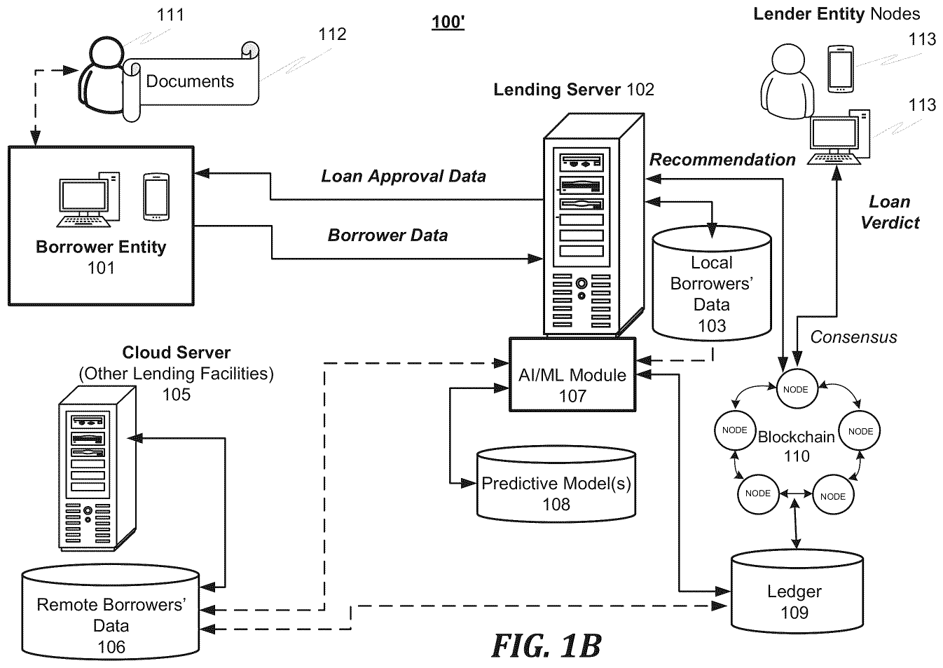

Turning to FIG. 1A, illustrated is a network diagram of a system for an DI-based automated loan processing based on user-related data and stored users′-related heuristics data consistent with the present disclosure.

Referring to FIG. 1A, the example network 100 includes the lending server (LS) node 102 connected to a cloud server node(s) 105 over a network. The LS node 102 is configured to host an AI/ML module 107. The LS node 102 may receive user data from a user 111. The LS node 102 may receive a call data related to communication between the user 111 and responding entity that may be implemented as chat bot (not shown).

The call data may have language indicator metadata representing the language of the user used during the call. In some embodiments, the call data may be processed by the LS node 102 using the pre-trained large language models. The LS node 102 may derive the language indicator and parse out the call data based on the language indicator metadata. In other words, the key features of the call data may be, advantageously, derived from the call data based on the language of the call.

In some embodiments, the language indicator may serve as a kind of a linguistic profile associated with the call. The language indicator may guide the AI/ML module 107 in dynamically tailoring the loan processing. Depending on the language indicated, the LS node 102 could engage specialized language models or apply unique natural language processing techniques optimized for that language.

Regarding the global reach of the disclosed systems and methods, a cultural intelligence layer may be added to the language indicator. The goal of this layer is for the system to not only recognize the language, but also adapt its recommendations and interactions to be culturally sensitive and appropriate for the caller (i.e., the user or a representative). In some embodiments, the disclosed framework may employ integrated translation capabilities. This may allow both the user 111 and the user entity 101 to communicate effortlessly, no matter where they are in the world or what languages they use. The language indicator metadata may initiate this feature, making the system truly globally effective.

The LS node 102 may query a local users' database for the historical local users' data 103 associated with the current user 111 data. The LS node 102 may acquire relevant remote users' data 106 from a remote database residing on a cloud server 105. The remote users' data 106 may be collected from other lending facilities. The remote users' data 106 may be collected from the users of the same (or similar) condition, age, language, etc. as the local users' who are associated with the current user-related data of the user 111 based on submitted documents 112.

The LS node 102 may generate a feature vector or classifier data based on the user-related data, user 111 call data and the collected users' data (i.e., pre-stored local data 103 and remote data 106). The LS node 102 may ingest the feature vector data into an AI/ML module 107. The AI/ML module 107 may generate a predictive model(s) 108 based on the feature vector data to predict lending parameters for automatically generating a lending verdict and/or lending recommendations to be provided to the lender entities 113 (e.g., loan officers, underwriters, other practitioners, etc.). The lending parameters and/or loan risk assessment parameters may be further analyzed by the LS node 102 prior to generation of the loan verdict. In some embodiments, the lending parameters may be used for adjustment of the loan terms. Once the loan verdict is determined, an alert/notification may be sent to the lending entity 113 for a final approval.

FIG. 1B illustrates a network diagram of a system for an AI-based automated loan processing based on user-related data and stored users′-related heuristics data implemented over a blockchain consistent with the present disclosure.

Referring to FIG. 1B, the example network 100′ includes the lending server (LS) node 102 connected to a cloud server node(s) 105 over a network. The LS node 102 is configured to host an AI/ML module 107. The LS node 102 may receive user data from a user 111. The LS node 102 may receive a call data related to communication between the user 111 and responding entity that may be implemented as a chat bot (not shown).

The call data may have language indicator metadata representing the language of the user used during the call. In some embodiments, the call data may be processed by the LS node 102 using the pre-trained large language models. The LS node 102 may derive the language indicator and parse out the call data based on the language indicator metadata. In other words, the key features of the call data may be, advantageously, derived from the call data based on the language of the call.

In some embodiments, the language indicator may serve as a kind of a linguistic profile associated with the call. The language indicator may guide the AI/ML module 107 in dynamically tailoring the loan processing. Depending on the language indicated, the LS node 102 could engage specialized language models or apply unique natural language processing techniques optimized for that language.

In some embodiments, the disclosed framework may employ integrated translation capabilities. This may allow both the user 111 and the user entity 101 to communicate effortlessly, no matter where they are in the world or what languages they use. The language indicator metadata may initiate this feature, making the system truly globally effective.

The LS node 102 may query a local users' database for the historical local users' data 103 associated with the current user 111 data. The LS node 102 may acquire relevant remote users' data 106 from a remote database residing on a cloud server 105. The remote users' data 106 may be collected from other lending facilities. The remote users' data 106 may be collected from the users of the same (or similar) condition, age, language, etc. as the local users' who are associated with the current user-related data of the user 111 based on submitted documents 112.

The LS node 102 may generate a feature vector or classifier data based on the user-related data, user 111 call data and the collected users' data (i.e., pre-stored local data 103 and remote data 106). The LS node 102 may ingest the feature vector data into an AI/ML module 107. The AI/ML module 107 may generate a predictive model(s) 108 based on the feature vector data to predict lending parameters for automatically generating a lending verdict and/or lending recommendations to be provided to the lender entities 113 (e.g., loan officers, underwriters, other practitioners, etc.). The lending parameters and/or loan risk assessment parameters may be further analyzed by the LS node 102 prior to generation of the loan verdict. In some embodiments, the lending parameters may be used for adjustment of the loan terms. Once the loan verdict is determined, an alert/notification may be sent to the lender entity nodes 113 for a final approval.

In some embodiments, the LS node 102 may receive the predicted lending parameters from a permissioned blockchain 110 ledger 109 based on a consensus from the lender entity nodes 113 confirming, for example, loan approval/disapproval verdict, payment plan, schedule and other loan conditions. Additionally, confidential historical user-related information and previous users′-related lending parameters may also be acquired from the permissioned blockchain 110. The newly acquired user-related data with corresponding predicted loan verdict and lending recommendation parameters data may be also recorded on the ledger 109 of the blockchain 110 so it can be used as training data for the predictive model(s) 108. In this implementation the LS node 102, the cloud server 105, the lender entity nodes 113 and user entities(s) 101 may serve as blockchain 110 peer nodes. In some embodiments, local users' data 103 and remote users' data 106 may be duplicated on the blockchain ledger 109 for higher security of storage.

The AI/ML module 107 may host, compile, generate and train a predictive model(s) 108 to predict the lending verdict and/or lending recommendation parameters for the user 111 in response to the specific relevant pre-stored users′-related data acquired from the blockchain 110 ledger 109. This way, the current lending verdict and/or lending parameters may be predicted based not only on the current user-related data and current user call data, but also based on the previously collected heuristics and users′-related data associated with the given user 111 data or current lending parameters generated based on the user data and call data. This way, the most optimal way of handling the user's loan application, such as the best loan specialist(s) is selected for processing the loan application of the user 111, for the most likely successful closing. After the lone is closed, the related documents may be converted into unique secure NFT assets to be recorded on the blockchain to be used for lending model training.

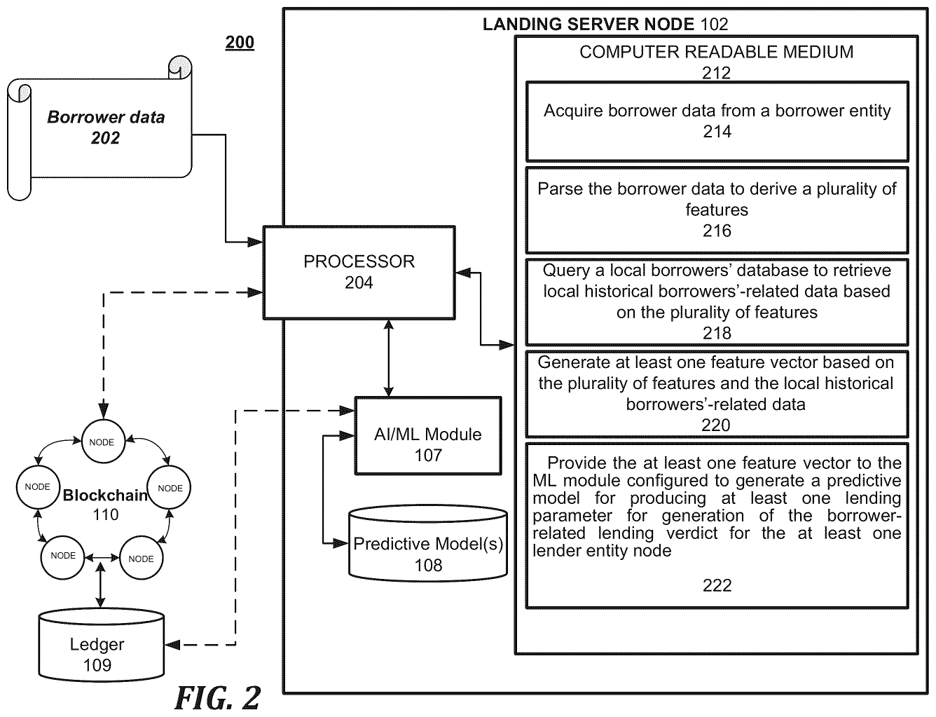

FIG. 2 illustrates a network diagram of a system including detailed features of a lending server (LS) node consistent with the present disclosure.

Referring to FIG. 2, the example network 200 includes the LS node 102 connected to the user entity 101 (FIGS. 1A-B) to receive user data 201. The LS node 102 may be connected to a chat bot (not shown) to receive call data.

The LS node 102 is configured to host an AI/ML module 107. As discussed above with respect to FIGS. 1A-B, the LS node 102 may receive the user data provided by the user entities(s) 101 (FIG. 1A) and pre-stored users' data retrieved from local and remote databases. As discussed above, the pre-stored users' data may be retrieved from the ledger 109 of the blockchain 110.

The AI/ML module 107 may host, compile, generate and train a predictive model(s) 108 based on the received user-related data 202 and the users′-related data provided by the LS node 102. As discussed above, the AI/ML module 107 may provide predictive outputs data in the form of lending parameters for automatic generation of landing verdict and/or landing recommendations for the lender entities 113 (see FIG. 1B). The LS node 102 may process the predictive outputs data received from the AI/ML module 107 to generate the lending verdict and/or lending risk assessment recommendation pertaining to a particular user engagement.

In some embodiments, the LS node 102 may acquire user data periodically in order to check if new lending verdict or updated lending recommendations need to be generated or the loan terms needs to be reset. In another embodiment, the LS node 102 may continually monitor other users' data and may detect a parameter that deviates from a previous recorded parameter (or from a median reading value) by a margin that exceeds a threshold value pre-set for this particular parameter. For example, if a user's income or profit/loss data changes, this may cause a change in a lending verdict or loan risk assessment. Accordingly, once the threshold is met or exceeded by at least one parameter of the user, the LS node 102 may provide the currently acquired user parameter to the AI/ML module 107 to generate an updated loan verdict or lending recommendation parameters based on the current user's conditions and updated loan risk assessment parameters.

While this example describes in detail only one LS node 102, multiple such nodes may be connected to the network and to the blockchain 110. It should be understood that the LS node 102 may include additional components and that some of the components described herein may be removed and/or modified without departing from a scope of the LS node 102 disclosed herein. The LS node 102 may be a computing device or a server computer, or the like, and may include a processor 204, which may be a semiconductor-based microprocessor, a central processing unit (CPU), an application specific integrated circuit (ASIC), a field-programmable gate array (FPGA), and/or another hardware device. Although a single processor 204 is depicted, it should be understood that the LS node 102 may include multiple processors, multiple cores, or the like, without departing from the scope of the LS node 102 system.

The LS node 102 may also include a non-transitory computer readable medium 212 that may have stored thereon machine-readable instructions executable by the processor 204. Examples of the machine-readable instructions are shown as 214-222 and are further discussed below. Examples of the non-transitory computer readable medium 212 may include an electronic, magnetic, optical, or other physical storage device that contains or stores executable instructions. For example, the non-transitory computer readable medium 212 may be a Random-Access memory (RAM), an Electrically Erasable Programmable Read-Only Memory (EEPROM), a hard disk, an optical disc, or other type of storage device.

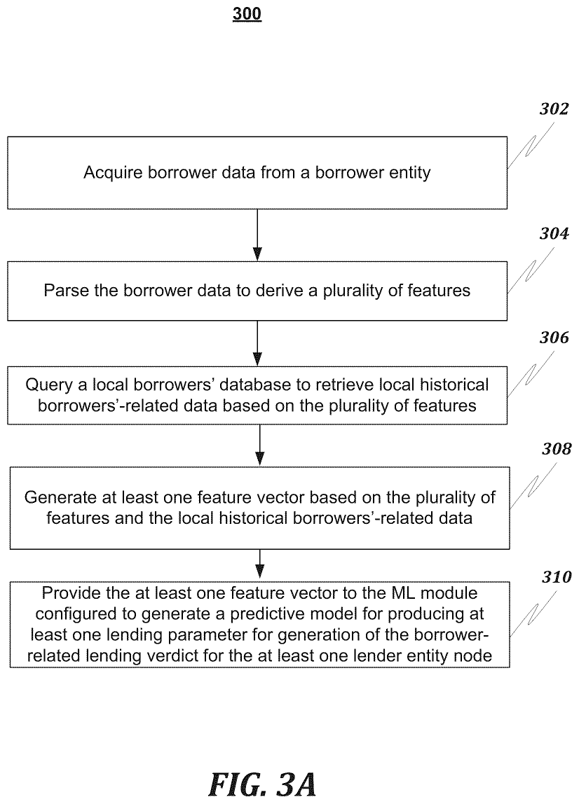

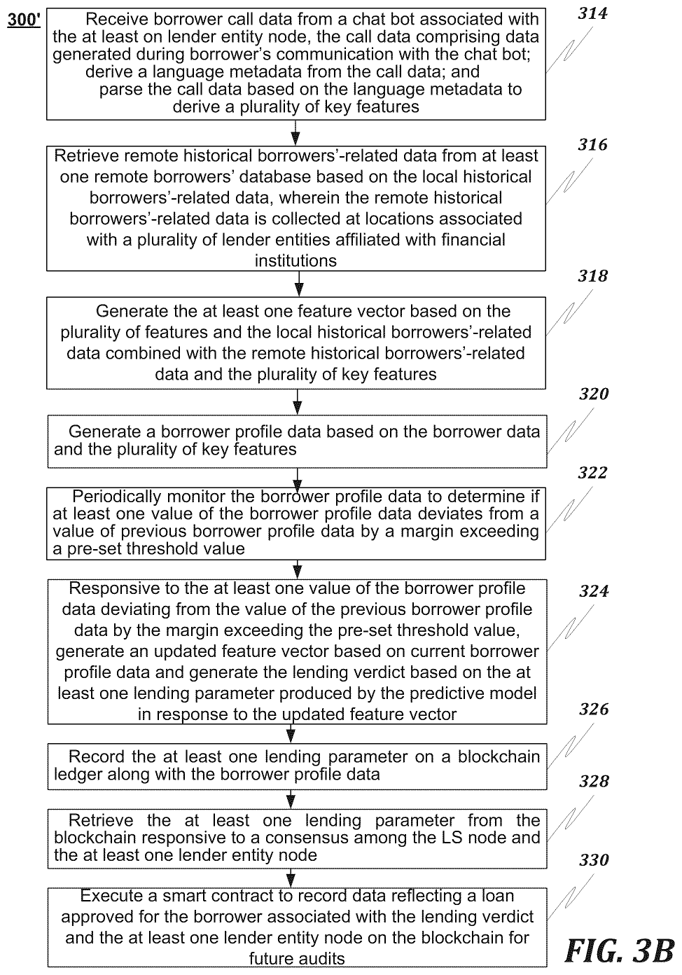

The processor 204 may fetch, decode, and execute the machine-readable instructions 214 to acquire user data from a user entity 101. The processor 204 may fetch, decode, and execute the machine-readable instructions 216 to analyze and parse the user data to derive a plurality of features. Such analysis is discussed below in more detail in relation to FIGS. 3A-3B, infra. The processor 204 may fetch, decode, and execute the machine-readable instructions 218 to query a local users' database to retrieve local historical users′-related data based on the plurality of features. The processor 204 may fetch, decode, and execute the machine-readable instructions 220 to generate at least one feature vector based on the plurality of features and the local historical users′-related data.

The processor 204 may fetch, decode, and execute the machine-readable instructions 222 to generate and provide the at least one n-dimensional feature vector to the ML module 107 configured to generate a predictive model 108 for producing at least one lending parameter for generation of the user-related lending verdict for the at least one lender entity node 113.

The permissioned blockchain 110 may be configured to use one or more smart contracts that manage transactions for multiple participating nodes and for recording the transactions on the ledger 109.

FIG. 3A illustrates a flowchart of a method 300 for an AI-based automated loan processing consistent with the present disclosure. According to some embodiments, disclosed steps of method 300 can be performed via the components of systems 100, 100′ and 200, as in relation to FIGS. 1A-2, discussed supra.

Referring to FIG. 3A, the method 300 may include one or more of the steps described below. In some embodiments, FIG. 3A illustrates a flow chart of an example method 300 executed by the LS 102 (see FIG. 2). It should be understood that method 300 depicted in FIG. 3A may include additional operations and that some of the operations described therein may be removed and/or modified without departing from the scope of the method 300. The description of the method 300 is also made with reference to the features depicted in FIG. 2 for purposes of illustration. Particularly, the processor 204 of the LS node 102 may execute some or all of the operations included in the method 300.

With reference to FIG. 3A, at block (or step, used interchangeably) 302, the processor 204 may acquire user data from a user entity, as discussed above. According to some embodiments, as discussed below, the borrow data may be acquired as part of a set of electronic documents. For example, digital assets of a user (e.g., bank statements, for example) can be identified and analyzed, and as a result, borrow data related to specifics need for a loan application may be identified.

In some embodiments, the electronic documents (e.g., digital assets) can be securely stored in a database, which as discussed herein, can be any type of known or to be known centralized or decentralized storage. For example, the storage can be a public blockchain, private blockchain, look-up table (LUT), memory, memory stack, distributed ledger and/or any other type of secure data repository.

In some embodiments, the electronic document can be stored as a digital file, such as, for example, a non-fungible token (NFT). For example, the known or to be know methods for creating a NFT of a set of electronic documents (e.g., an NFT for the set and/or an NFT for each document in a set) can be utilized. Indeed, in some embodiments, any type of known or to be known tokenization methods can be utilized to convert an electronic document (or digital asset, and/or user data, for example) to a digital token, which can then be stored in the manner discussed above. As discussed herein, such tokenization and storage provides secure measures to check the validity of user data, as well as securely hold the electronic documents for subsequent analysis and verification checks.

At block 304, the processor 204 may parse the user data to derive a plurality of features. According to some embodiments, processor 204 can analyze the user data by parsing the data, and extracting, deriving or otherwise identifying the plurality of features.

In some embodiments, as discussed above, such analysis can be performed via process 204 implementing any type of known or to be known computational analysis technique, algorithm, mechanism or technology to analyze the user data.

In some embodiments, processor 204 may execute and/or include a specific trained artificial intelligence/machine learning model (AI/ML), a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, processor 204 may leverage a LLM(s), whether known or to be known. As discussed above, a LLM is a type of AI system designed to understand and generate human-like text based on the input it receives. The LLM can implement technology that involves deep learning, training data and natural language processing (NLP). Large language models are built using deep learning techniques, specifically using a type of neural network called a transformer. These networks have many layers and millions or even billions of parameters. LLMs can be trained on vast amounts of text data from the internet, books, articles, and other sources to learn grammar, facts, and reasoning abilities. The training data helps them understand context and language patterns. LLMs can use NLP techniques to process and understand text. This includes tasks like tokenization, part-of-speech tagging, and named entity recognition.

LLMs can include functionality related to, but not limited to, text generation, language translation, text summarization, question answering, conversational AI, text classification, language understanding, content generation, and the like. Accordingly, LLMs can generate, comprehend, analyze and output human-like outputs (e.g., text, speech, audio, video, and the like) based on a given input, prompt or context. Accordingly, LLMs, which can be characterized as transformer-based LLMs, involve deep learning architectures that utilizes self-attention mechanisms and massive-scale pre-training on input data to achieve NLP understanding and generation. Such current and to-be-developed models can aid AI systems in handling human language and human interactions therefrom.

In some embodiments, processor 204 may be configured to utilize one or more AI/ML techniques chosen from, but not limited to, computer vision, feature vector analysis, decision trees, boosting, support-vector machines, neural networks, nearest neighbor algorithms, Naive Bayes, bagging, random forests, logistic regression, and the like. By way of a non-limiting example, processor 204 can implement an XGBoost algorithm for regression and/or classification to analyze the sensor data, as discussed herein.

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a. define Neural Network architecture/model for a specific transaction, specific user, specific lender, and the like, or some combination thereof,
b. transfer the input data to the neural network model (e.g., data for the requestor, for example; or training data for similar types of requestors, for example),
c. train the model (e.g., incrementally),
d. determine the accuracy for a specific number of timesteps,
e. apply the trained model to process the newly-received input data (from the requestor)—for example, enter the data from the requestor into a layer of a neural network, with another layer having the analyzed training data, whereby a comparison of their respective vectors can be performed, and the like),
f. optionally and in parallel, continue to train the trained model with a predetermined periodicity.

In some embodiments and, optionally, in combination of any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

Accordingly, in block 304, processor 304 can, via the AI/ML and/or LLM analysis discussed above, determine the plurality of features from the user data.

At block 306, the processor 204 may compile query that includes information related to the determine plurality of features (from block 304). In some embodiments, block 306 can include the processor 204 identifying and searching a local users' database based on the query to retrieve local historical users′-related data based on the plurality of features.

At block 308, the processor 204 may generate at least one feature vector based on the plurality of features and the local historical users′-related data (retrieved from the query from block 306). At block 310, the processor 204 may provide the at least one feature vector to a AI/ML and/or LLM model, such that a predictive model can be generated for producing at least one lending parameter for generation of the user-related lending verdict for the at least one lender entity node. According to some embodiments, the user-related lending verdict is compiled and output as an electronic data structure that includes information related to reasoning as to a determination of loan applicability of the user, as determined via the AI/ML and/or LLM model, via the predictive model, as discussed above.

As discussed herein, such verdict can be compiled as a set of executable instructions, that an upon approval indication in the verdict data structure, can be sent to the lender such that an electronic account housing the requested digital assets can be securely accessed via the read/write access provided via execution of the executable instructions. Thus, the requested funds, for example, can be automatically and securely (e.g., according to a known or to be known encryption, for example) accessed and sent to the electronic account of the user.

In some embodiments, the determined/generated verdict (from Step 310) can be tokenized and stored, which can be performed in a similar manner as discussed in relation to Step 302, discussed supra.

FIG. 3B illustrates a flowchart providing a method 300′ for an DI-based automated loan processing consistent with the present disclosure. According to some embodiments, the disclosed steps of method 300′ can be performed via the components of systems 100, 100′ and 200, as in relation to FIGS. 1A-2, discussed supra.

Referring to FIG. 3B, the method 300′ may include one or more of the steps described below. In some embodiments, FIG. 3B illustrates a flow chart of an example method executed by the LS 102 (see FIG. 2). It should be understood that method 300′ depicted in FIG. 3B may include additional operations and that some of the operations described therein may be removed and/or modified without departing from the scope of the method 300′. The description of the method 300′ is also made with reference to the features depicted in FIG. 2 for purposes of illustration. Particularly, the processor 204 of the LS 102 may execute some or all of the operations included in the method 300′.

With reference to FIG. 3B, at block 314, the processor 204 may: receive user call data from a chat bot associated with the at least on lender entity node, the call data comprising audio data generated during user's call; derive a language metadata from the audio data; and parse the audio data based on the language metadata to derive a plurality of key features. Accordingly, in some embodiments, block 314 can include sub-steps related to the processing performed by process 204 to perform the i) receiving operation, ii) deriving operation, and iii) parsing operations. Accordingly, the processing operations performed in block 314 can be performed via similar AI/ML and/or LLM processing discussed above at least respective to block 304.

At block 316, the processor 204 may retrieve remote historical users′-related data from at least one remote users' database based on the local historical users′-related data, wherein the remote historical users′-related data is collected at locations associated with a plurality of lender entities affiliated with financial institutions. Accordingly, in some embodiments, the retrieval by process 204 can be performed in a similar manner as discussed above in relation to at least to block 306, where a query can be correspondingly compiled and executed in relation to the users' database.

At block 318, the processor 204 may generate the at least one n-dimensional feature vector based on the plurality of features and the local historical users′-related data combined with the remote historical users′-related data and the plurality of key features. According to some embodiments, process 204 can implement the AI/ML and/or LLM model(s) to generate the feature vector by transforming the corresponding data into nodes and vectors, where the nodes can correspond to a type of data, and the vectors can correlate to relationships among the nodes and the data that is being represented.

At block 320, the processor 204 may generate a user profile data based on the user data and the plurality of key features. At block 322, the processor 204 can monitor the user profile data to determine if at least one value of the user profile data deviates from a value of previous user profile data by a margin exceeding a pre-set threshold value. In some embodiments, the monitoring can be performed periodically, continuously and/or according to an event/criteria (e.g., a loan application request, lender activity, user activity, a time period, loan amount, loan type, location, property type, asset type, and the like, or some combination thereof).

At block 324, the processor 204 may, responsive to the at least one value of the user profile data deviating from the value of the previous user profile data by the margin exceeding the pre-set threshold value, generate an updated feature vector based on current user profile data and generate the lending verdict based on the at least one lending parameter produced by the predictive model in response to the updated feature vector. Such feature vector generation can be performed in a similar manner as discussed above.

In some embodiments, the determined/generated verdict (from Step 324) can be tokenized and stored, which can be performed in a similar manner as discussed in relation to Step 302, discussed supra.

At block 326, the processor 204 may record (e.g., store) the at least one lending parameter on a blockchain ledger along with the user profile data. At block 328, the processor 204 may retrieve the at least one lending parameter from the blockchain responsive to a consensus among the LS node and the at least one lender entity node.

At block 330, the processor 204 may generate and execute a smart contract to record data reflecting a loan approved for the user associated with the lending verdict and the at least one lender entity node on the blockchain for future audits. According to some embodiments, the smart contract can include executable instructions that securely govern, dictate and/or manage how the loan assets can be secured, transferred, managed, used and/or stored, which can be tied to the approval of the loan, as discussed herein.

In some embodiments, the lending parameters' model may be generated by the AI/ML module 107 that may use training data sets to improve accuracy of the prediction of the lending parameters for the lender entities 113 (FIG. 1A). The lending parameters used in training data sets may be stored in a centralized local database (such as one used for storing local users' data 103 depicted in FIG. 1A). In some embodiments, a neural network may be used in the AI/ML module 107 for lending parameters modeling and risk assessment predictions.

In some embodiments, the AI/ML module 107 may use a decentralized storage such as a blockchain 110 (see FIG. 1B) that is a distributed storage system, which includes multiple nodes that communicate with each other. The decentralized storage includes an append-only immutable data structure resembling a distributed ledger capable of maintaining records between mutually untrusted parties. The untrusted parties are referred to herein as peers or peer nodes. Each peer maintains a copy of the parameter(s) records and no single peer can modify the records without a consensus being reached among the distributed peers. For example, the peers 101, 113, 105 and 102 (FIG. 1B) may execute a consensus protocol to validate blockchain 110 storage transactions, group the storage transactions into blocks, and build a hash chain over the blocks. This process forms the ledger 109 by ordering the storage transactions, as is necessary, for consistency. In various embodiments, a permissioned and/or a permissionless blockchain can be used. In a public or permissionless blockchain, anyone can participate without a specific identity. Public blockchains can involve assets and use consensus based on various protocols such as Proof of Work (PoW). On the other hand, a permissioned blockchain provides secure interactions among a group of entities which share a common goal such as storing lending parameters for efficient processing of applications for users (e.g., users).

In some embodiments, a permissioned (private) blockchain can be utilized, which can operate arbitrary, programmable logic, tailored to a decentralized storage scheme and referred to as “smart contracts” or “chaincodes.” In some embodiments, specialized chaincodes may exist for management functions and parameters which are referred to as system chaincodes. The disclosed framework can further utilize smart contracts that are trusted distributed applications which leverage tamper-proof properties of the blockchain database and an underlying agreement between nodes, which is referred to as an endorsement or endorsement policy. Blockchain transactions associated with this application can be “endorsed” before being committed to the blockchain while transactions, which are not endorsed, are disregarded. An endorsement policy allows chaincodes to specify endorsers for a transaction in the form of a set of peer nodes that are necessary for endorsement. When a client sends the transaction to the peers specified in the endorsement policy, the transaction is executed to validate the transaction. After a validation, the transactions enter an ordering phase in which a consensus protocol is used to produce an ordered sequence of endorsed transactions grouped into blocks.

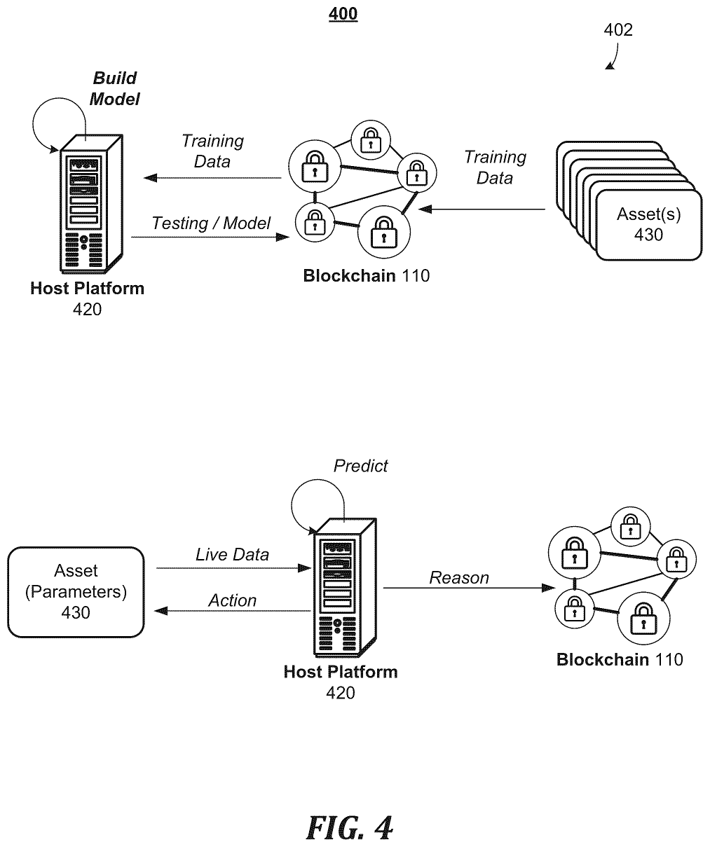

In the non-limiting example depicted in FIG. 4, a host platform 420 (such as the LS node 102) builds and deploys a machine learning model for predictive monitoring of assets 430. Here, the host platform 420 may be a cloud platform, an industrial server, a web server, a personal computer, a user device, and the like. Assets 430 can represent, among other types of electronic information, lending parameters. Moreover, the blockchain 110 can be used to significantly improve both a training process 402 of the machine learning model and the lending parameters' predictive process 405 based on a trained machine learning model. For example, in 402, rather than requiring a data scientist/engineer or other user to collect the data, historical data (heuristics—i.e., users′-related data) may be stored by the assets 430 themselves (or through an intermediary, not shown) on the blockchain 110.

Accordingly, as discussed above, according to some embodiments, the disclosed implementation can significantly reduce the collection time needed by the host platform 420 when performing predictive model training. Thus, computer, network and/or memory/storage resource usage can be reduced, thereby evidencing an increase in computational efficiency and accuracy when processing loan applications, thereby enabling real-time, dynamically considerate decisions to be automatically performed in a novel manner. For example, using smart contracts, data can be directly and reliably transferred straight from its place of origin (e.g., from the LS node 102 or from users' databases 103 and 106 depicted in FIGS. 1A-1B) to the blockchain 110. By using the blockchain 110 to ensure the security and ownership of the collected data, smart contracts may directly send the data from the assets to the entities that use the data for building a machine learning model. This allows for sharing of data among the assets 430. The collected data may be stored in the blockchain 110 based on a consensus mechanism. The consensus mechanism pulls in (permissioned nodes) to ensure that the data being recorded is verified and accurate. The data recorded is time-stamped, cryptographically signed, and immutable. It is therefore auditable, transparent, and secure.

Furthermore, training of the machine learning model on the collected data may take rounds of refinement and testing by the host platform 420. Each round may be based on additional data or data that was not previously considered to help expand the knowledge of the machine learning model. In 402, the different training and testing steps (and the data associated therewith) may be stored on the blockchain 110 by the host platform 420. Each refinement of the machine learning model (e.g., changes in variables, weights, etc.) may be stored on the blockchain 110. This, advantageously, provides verifiable proof of how the model was trained and what data was used to train the model. Furthermore, when the host platform 420 has achieved a finally trained model, the resulting model itself may be stored on the blockchain 110.

After the model has been trained, it may be deployed to a live environment where it can make recommendation-related predictions/decisions based on the execution of the final trained machine learning model using the prediction parameters. In this example, data fed back from the asset 430 may be input into the machine learning model and may be used to make event predictions such as most optimal loan approval and loan scheduling parameters for the user based on the recorded user's data. Determinations made by the execution of the machine learning model (e.g., lending verdict and lending recommendations, loan risk assessment data, etc.) at the host platform 420 may be stored on the blockchain 110 to provide auditable/verifiable proof. As one non-limiting example, the machine learning model may predict a future change of a part of the asset 430 (the lending recommendation parameters—i.e., assessment of risk of unsuccessful loan approval). The data behind this decision may be stored by the host platform 420 on the blockchain 110.

As discussed above, in some embodiments, the features and/or the actions described and/or depicted herein can occur on or with respect to the blockchain 110. The above embodiments of the present disclosure may be implemented in hardware, in computer-readable instructions executed by a processor, in firmware, or in a combination of the above. The computer computer-readable instructions may be embodied on a computer-readable medium, such as a storage medium. For example, the computer computer-readable instructions may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

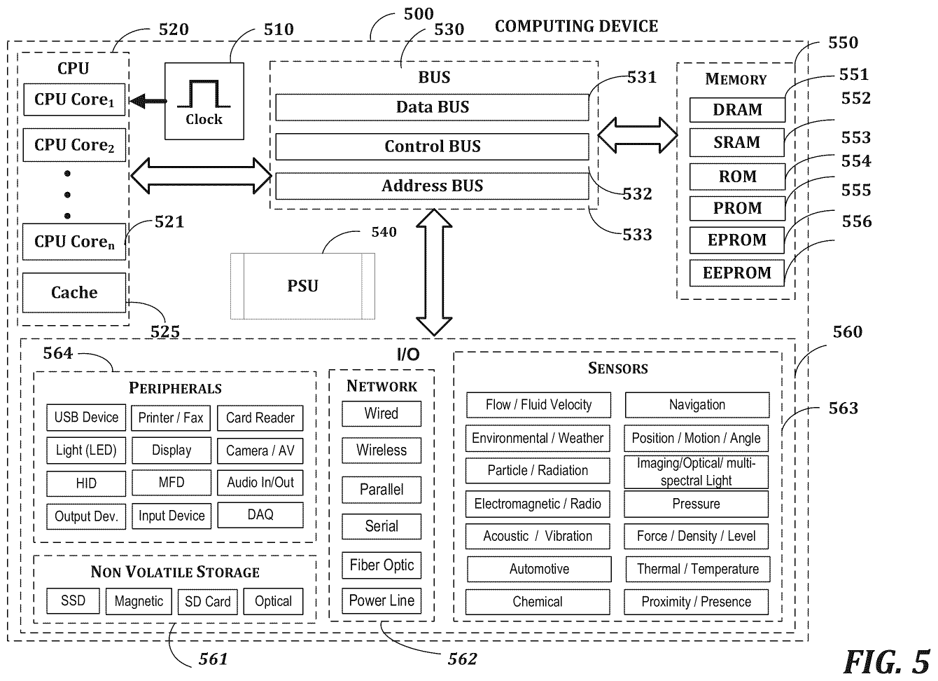

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative embodiment, the processor and the storage medium may reside as discrete components. For example, FIG. 5 illustrates an example computing device (e.g., a server node) 500, which may represent or be integrated in any of the above-described components, etc.

FIG. 5 illustrates a block diagram of a system including computing device 500. The computing device 500 may comprise, but not be limited to the following:
Mobile computing device, such as, but is not limited to, a laptop, a tablet, a smartphone, a drone, a wearable, an embedded device, a handheld device, an Arduino, an industrial device, or a remotely operable recording device;
A supercomputer, an exa-scale supercomputer, a mainframe, or a quantum computer;
A minicomputer, wherein the minicomputer computing device can include, for example, but is not limited to, an IBM AS500/iSeries/System I, A DEC VAX/PDP, a HP3000, a Honeywell-Bull DPS, a Texas Instruments TI-990, or a Wang Laboratories VS Series;
A microcomputer, wherein the microcomputer computing device comprises, but is not limited to, a server, wherein a server may be rack mounted, a workstation, an industrial device, a raspberry pi, a desktop, and/or an embedded device;
The LS node 102 (see FIG. 2) may be hosted on a centralized server or on a cloud computing service. Although method 300 has been described to be performed by the LS node 102 implemented on a computing device 500, it should be understood that, in some embodiments, different operations may be performed by a plurality of the computing devices 500 in operative communication at least one network.

Embodiments of the present disclosure may comprise a computing device having a central processing unit (CPU) 520, a bus 530, a memory unit 550, a power supply unit (PSU) 550, and one or more Input/Output (I/O) units. The CPU 520 coupled to the memory unit 550 and the plurality of I/O units 560 via the bus 530, all of which are powered by the PSU 550. It should be understood that, in some embodiments, each disclosed unit may actually be a plurality of such units for the purposes of redundancy, high availability, and/or performance. The combination of the presently disclosed units is configured to perform the stages of any method disclosed herein.

Consistent with an embodiment of the disclosure, the aforementioned CPU 520, the bus 530, the memory unit 550, a PSU 550, and the plurality of I/O units 560 may be implemented in a computing device, such as computing device 500. Any suitable combination of hardware, software, or firmware may be used to implement the aforementioned units. For example, the CPU 520, the bus 530, and the memory unit 550 may be implemented with computing device 500 or any of other computing devices 500, in combination with computing device 500. The aforementioned system, device, and components are examples and other systems, devices, and components may comprise the aforementioned CPU 520, the bus 530, the memory unit 550, consistent with embodiments of the disclosure.

At least one computing device 500 may be embodied as any of the computing elements illustrated in all of the attached figures, including the LS node 102 (FIG. 2). A computing device 500 does not need to be electronic, nor even have a CPU 520, nor bus 530, nor memory unit 550. The definition of the computing device 500 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 500, especially if the processing is purposeful.

With reference to FIG. 5, a system consistent with an embodiment of the disclosure may include a computing device, such as computing device 500. In a basic configuration, computing device 500 may include at least one clock module 510, at least one CPU 520, at least one bus 530, and at least one memory unit 550, at least one PSU 550, and at least one I/O 560 module, wherein I/O module may be comprised of, but not limited to a non-volatile storage sub-module 561, a communication sub-module 562, a sensors sub-module 563, and a peripherals sub-module 565.

A system consistent with an embodiment of the disclosure the computing device 500 may include the clock module 510 may be known to a person having ordinary skill in the art as a clock generator, which produces clock signals. Clock signal is a particular type of signal that oscillates between a high and a low state and is used like a metronome to coordinate actions of digital circuits. Most integrated circuits (ICs) of sufficient complexity use a clock signal in order to synchronize different parts of the circuit, cycling at a rate slower than the worst-case internal propagation delays. The preeminent example of the aforementioned integrated circuit is the CPU 520, the central component of modern computers, which relies on a clock. The only exceptions are asynchronous circuits such as asynchronous CPUs. The clock 510 can comprise a plurality of embodiments, such as, but not limited to, single-phase clock which transmits all clock signals on effectively 1 wire, two-phase clock which distributes clock signals on two wires, each with non-overlapping pulses, and four-phase clock which distributes clock signals on 5 wires.

Many computing devices 500 use a “clock multiplier” which multiplies a lower frequency external clock to the appropriate clock rate of the CPU 520. This allows the CPU 520 to operate at a much higher frequency than the rest of the computer, which affords performance gains in situations where the CPU 520 does not need to wait on an external factor (like memory 550 or input/output 560). Some embodiments of the clock 510 may include dynamic frequency change, where the time between clock edges can vary widely from one edge to the next and back again.

A system consistent with an embodiment of the disclosure the computing device 500 may include the CPU unit 520 comprising at least one CPU Core 521. A plurality of CPU cores 521 may comprise identical CPU cores 521, such as, but not limited to, homogeneous multi-core systems. It is also possible for the plurality of CPU cores 521 to comprise different CPU cores 521, such as, but not limited to, heterogeneous multi-core systems, big.LITTLE systems and some AMD accelerated processing units (APU). The CPU unit 520 reads and executes program instructions which may be used across many application domains, for example, but not limited to, general purpose computing, embedded computing, network computing, digital signal processing (DSP), and graphics processing (GPU). The CPU unit 520 may run multiple instructions on separate CPU cores 521 at the same time. The CPU unit 520 may be integrated into at least one of a single integrated circuit die and multiple dies in a single chip package. The single integrated circuit die and multiple dies in a single chip package may contain a plurality of other aspects of the computing device 500, for example, but not limited to, the clock 510, the CPU 520, the bus 530, the memory 550, and I/O 560.

The CPU unit 520 may contain cache 522 such as, but not limited to, a level 1 cache, level 2 cache, level 3 cache or combination thereof. The aforementioned cache 522 may or may not be shared amongst a plurality of CPU cores 521. The cache 522 sharing comprises at least one of message passing and inter-core communication methods may be used for the at least one CPU Core 521 to communicate with the cache 522. The inter-core communication methods may comprise, but not limited to, bus, ring, two-dimensional mesh, and crossbar. The aforementioned CPU unit 520 may employ symmetric multiprocessing (SMP) design.

The plurality of the aforementioned CPU cores 521 may comprise soft microprocessor cores on a single field programmable gate array (FPGA), such as semiconductor intellectual property cores (IP Core). The plurality of CPU cores 521 architecture may be based on at least one of, but not limited to, Complex instruction set computing (CISC), Zero instruction set computing (ZISC), and Reduced instruction set computing (RISC). At least one of the performance-enhancing methods may be employed by the plurality of the CPU cores 521, for example, but not limited to Instruction-level parallelism (ILP) such as, but not limited to, superscalar pipelining, and Thread-level parallelism (TLP).

Consistent with the embodiments of the present disclosure, the aforementioned computing device 500 may employ a communication system that transfers data between components inside the aforementioned computing device 500, and/or the plurality of computing devices 500. The aforementioned communication system will be known to a person having ordinary skill in the art as a bus 530. The bus 530 may embody internal and/or external plurality of hardware and software components, for example, but not limited to a wire, optical fiber, communication protocols, and any physical arrangement that provides the same logical function as a parallel electrical bus. The bus 530 may comprise at least one of, but not limited to a parallel bus, wherein the parallel bus carry data words in parallel on multiple wires, and a serial bus, wherein the serial bus carry data in bit-serial form. The bus 530 may embody a plurality of topologies, for example, but not limited to, a multidrop/electrical parallel topology, a daisy chain topology, and a connected by switched hubs, such as USB bus. The bus 530 may comprise a plurality of embodiments, for example, but not limited to:
Internal data bus (data bus) 531/Memory bus
Control bus 532
Address bus 533
System Management Bus (SMBus)
Front-Side-Bus (FSB)
External Bus Interface (EBI)
Local bus
Expansion bus
Lightning bus
Controller Area Network (CAN bus)
Camera Link
ExpressCard
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)
HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as, but not limited to, Accelerated Graphics Port (AGP), Peripheral Component Interconnect extended (PCI-X), Peripheral Component Interconnect Express (PCI-e) (e.g., PCI Express Mini Card, PCI Express M.2 [Mini PCIe v2], PCI Express External Cabling [ePCIe], and PCI Express OCuLink [Optical Copper {Cu} Link]), Express Card, AdvancedTCA, AMC, Universal IO, Thunderbolt/Mini DisplayPort, Mobile PCIe (M-PCIe), U.2, and Non-Volatile Memory Express (NVMe)/Non-Volatile Memory Host Controller Interface Specification (NVMHCIS).
Industry Standard Architecture (ISA), including embodiments such as, but not limited to Extended ISA (EISA), PC/XT-bus/PC/AT-bus/PC/105 bus (e.g., PC/105-Plus, PCI/105-Express, PCI/105, and PCI-105), and Low Pin Count (LPC).
Music Instrument Digital Interface (MIDI)
Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1395 Interface/Firewire, Thunderbolt, and extensible Host Controller Interface (xHCI).

Consistent with the embodiments of the present disclosure, the aforementioned computing device 500 may employ hardware integrated circuits that store information for immediate use in the computing device 500, known to the person having ordinary skill in the art as primary storage or memory 550. The memory 550 operates at high speed, distinguishing it from the non-volatile storage sub-module 561, which may be referred to as secondary or tertiary storage, which provides slow-to-access information but offers higher capacities at lower cost. The contents contained in memory 550, may be transferred to secondary storage via techniques such as, but not limited to, virtual memory and swap. The memory 550 may be associated with addressable semiconductor memory, such as integrated circuits consisting of silicon-based transistors, used for example as primary storage but also other purposes in the computing device 500. The memory 550 may comprise a plurality of embodiments, such as, but not limited to volatile memory, non-volatile memory, and semi-volatile memory. It should be understood by a person having ordinary skill in the art that the ensuing are non-limiting examples of the aforementioned memory:
Volatile memory which requires power to maintain stored information, for example, but not limited to, Dynamic Random-Access Memory (DRAM) 551, Static Random-Access Memory (SRAM) 552, CPU Cache memory 525, Advanced Random-Access Memory (A-RAM), and other types of primary storage such as Random-Access Memory (RAM).
Non-volatile memory which can retain stored information even after power is removed, for example, but not limited to, Read-Only Memory (ROM) 553, Programmable ROM (PROM) 555, Erasable PROM (EPROM) 555, Electrically Erasable PROM (EEPROM) 556 (e.g., flash memory and Electrically Alterable PROM [EAPROM]), Mask ROM (MROM), One Time Programmable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory which may have some limited non-volatile duration after power is removed but loses data after said duration has passed. Semi-volatile memory provides high performance, durability, and other valuable characteristics typically associated with volatile memory, while providing some benefits of true non-volatile memory. The semi-volatile memory may comprise volatile and non-volatile memory and/or volatile memory with battery to provide power after power is removed. The semi-volatile memory may comprise, but not limited to spin-transfer torque RAM (STT-RAM).
Consistent with the embodiments of the present disclosure, the aforementioned computing device 500 may employ the communication system between an information processing system, such as the computing device 500, and the outside world, for example, but not limited to, human, environment, and another computing device 500. The aforementioned communication system will be known to a person having ordinary skill in the art as I/O 560. The I/O module 560 regulates a plurality of inputs and outputs with regard to the computing device 500, wherein the inputs are a plurality of signals and data received by the computing device 500, and the outputs are the plurality of signals and data sent from the computing device 500. The I/O module 560 interfaces a plurality of hardware, such as, but not limited to, non-volatile storage 561, communication devices 562, sensors 563, and peripherals 565. The plurality of hardware is used by at least one of, but not limited to, human, environment, and another computing device 500 to communicate with the present computing device 500. The I/O module 560 may comprise a plurality of forms, for example, but not limited to channel I/O, port mapped I/O, asynchronous I/O, and Direct Memory Access (DMA).
Consistent with the embodiments of the present disclosure, the aforementioned computing device 500 may employ the non-volatile storage sub-module 561, which may be referred to by a person having ordinary skill in the art as one of secondary storage, external memory, tertiary storage, off-line storage, and auxiliary storage. The non-volatile storage sub-module 561 may not be accessed directly by the CPU 520 without using an intermediate area in the memory 550. The non-volatile storage sub-module 561 does not lose data when power is removed and may be two orders of magnitude less costly than storage used in memory modules, at the expense of speed and latency. The non-volatile storage sub-module 561 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (561) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD±RW/DVD+R DL/DVD-RAM/HD-DVD), Blu-ray Disk (BD) (BD-ROM/BD-R/BD-RE/BD-R DL/BD-RE DL), and Ultra-Density Optical (UDO).
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor.
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD).

Consistent with the embodiments of the present disclosure, the aforementioned computing device 500 may employ the communication sub-module 562 as a subset of the I/O 560, which may be referred to by a person having ordinary skill in the art as at least one of, but not limited to, computer network, data network, and network. The network allows computing devices 500 to exchange data using connections, which may be known to a person having ordinary skill in the art as data links, between network nodes. The nodes comprise network computer devices 500 that originate, route, and terminate data. The nodes are identified by network addresses and can include a plurality of hosts consistent with the embodiments of a computing device 500. The aforementioned embodiments include, but not limited to personal computers, phones, servers, drones, and networking devices such as, but not limited to, hubs, switches, routers, modems, and firewalls.

Two nodes can be networked together, when one computing device 500 is able to exchange information with the other computing device 500, whether or not they have a direct connection with each other. The communication sub-module 562 supports a plurality of applications and services, such as, but not limited to World Wide Web (WWW), digital video and audio, shared use of application and storage computing devices 500, printers/scanners/fax machines, email/online chat/instant messaging, remote control, distributed computing, etc. The network may comprise a plurality of transmission mediums, such as, but not limited to conductive wire, fiber optics, and wireless. The network may comprise a plurality of communications protocols to organize network traffic, wherein application-specific communications protocols are layered, may be known to a person having ordinary skill in the art as carried as payload, over other more general communications protocols. The plurality of communications protocols may comprise, but not limited to, IEEE 802, ethernet, Wireless LAN (WLAN/Wi-Fi), Internet Protocol (IP) suite (e.g., TCP/IP, UDP, Internet Protocol version 5 [IPv5], and Internet Protocol version 6 [IPv6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], and Integrated Digital Enhanced Network [IDEN]).

The communication sub-module 562 may comprise a plurality of size, topology, traffic control mechanism and organizational intent. The communication sub-module 562 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Cellular systems embody technologies such as, but not limited to, 3G, 5G (such as WiMax and LTE), and 5G (short and long wavelength).
Parallel communications, such as, but not limited to, LPT ports.
Serial communications, such as, but not limited to, RS-232 and USB.
Fiber Optic communications, such as, but not limited to, Single-mode optical fiber (SMF) and Multi-mode optical fiber (MMF).
Power Line and wireless communications

The aforementioned network may comprise a plurality of layouts, such as, but not limited to, bus network such as ethernet, star network such as Wi-Fi, ring network, mesh network, fully connected network, and tree network. The network can be characterized by its physical capacity or its organizational purpose. Use of the network, including user authorization and access rights, differ accordingly. The characterization may include, but not limited to nanoscale network, Personal Area Network (PAN), Local Area Network (LAN), Home Area Network (HAN), Storage Area Network (SAN), Campus Area Network (CAN), backbone network, Metropolitan Area Network (MAN), Wide Area Network (WAN), enterprise private network, Virtual Private Network (VPN), and Global Area Network (GAN).

Consistent with the embodiments of the present disclosure, the aforementioned computing device 500 may employ the sensors sub-module 563 as a subset of the I/O 560. The sensors sub-module 563 comprises at least one of the devices, modules, and subsystems whose purpose is to detect events or changes in its environment and send the information to the computing device 500. Sensors are sensitive to the measured property, are not sensitive to any property not measured, but may be encountered in its application, and do not significantly influence the measured property. The sensors sub-module 563 may comprise a plurality of digital devices and analog devices, wherein if an analog device is used, an Analog to Digital (A-to-D) converter must be employed to interface the said device with the computing device 500. The sensors may be subject to a plurality of deviations that limit sensor accuracy.

Consistent with the embodiments of the present disclosure, the aforementioned computing device 500 may employ the peripherals sub-module 562 as a subset of the I/O 560. The peripheral sub-module 565 comprises ancillary devices used to put information into and get information out of the computing device 500. There are 3 categories of devices comprising the peripheral sub-module 565, which exist based on their relationship with the computing device 500, input devices, output devices, and input/output devices. Input devices send at least one of data and instructions to the computing device 500. Input devices can be categorized based on, but not limited to:
Modality of input, such as, but not limited to, mechanical motion, audio, visual, and tactile.
Whether the input is discrete, such as but not limited to, pressing a key, or continuous such as, but not limited to position of a mouse.
The number of degrees of freedom involved, such as, but not limited to, two-dimensional mice vs three-dimensional mice used for Computer-Aided Design (CAD) applications.

Output devices provide output from the computing device 500. Output devices convert electronically generated information into a form that can be presented to humans. Input/output devices that perform both input and output functions. It should be understood by a person having ordinary skill in the art that the ensuing are non-limiting embodiments of the aforementioned peripheral sub-module 565:

### Input Devices:

Human Interface Devices (HID), such as, but not limited to, pointing device (e.g., mouse, touchpad, joystick, touchscreen, game controller/gamepad, remote, light pen, light gun, Wii remote, jog dial, shuttle, and knob), keyboard, graphics tablet, digital pen, gesture recognition devices, magnetic ink character recognition, Sip-and-Puff (SNP) device, and Language Acquisition Device (LAD).
High degree of freedom devices, which require up to six degrees of freedom, such as, but not limited to, camera gimbals, Cave Automatic Virtual Environment (CAVE), and virtual reality systems.
Video Input devices are used to digitize images or video from the outside world into the computing device 500. The information can be stored in a multitude of formats depending on the user's requirement. Examples of types of video input devices include, but not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
Audio input devices are used to capture sound. In some cases, an audio output device can be used as an input device, in order to capture produced sound. Audio input devices allow a user to send audio signals to the computing device 500 for at least one of processing, recording, and carrying out commands. Devices such as microphones allow users to speak to the computer in order to record a voice message or navigate software. Aside from recording, audio input devices are also used with speech recognition software. Examples of types of audio input devices include, but not limited to microphone, Musical Instrument Digital Interface (MIDI) devices such as, but not limited to a keyboard, and headset.
Data Acquisition (DAQ) devices convert at least one of analog signals and physical parameters to digital values for processing by the computing device 500. Examples of DAQ devices may include, but not limited to, Analog to Digital Converter (ADC), data logger, signal conditioning circuitry, multiplexer, and Time to Digital Converter (TDC).

Output Devices may further comprise, but not be limited to:
Display devices, which convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).

Printers, such as, but not limited to, inkjet printers, laser printers, 3D printers, solid ink printers and plotters.
Audio and Video (AV) devices, such as, but not limited to, speakers, headphones, amplifiers and lights, which include lamps, strobes, DJ lighting, stage lighting, architectural lighting, special effect lighting, and lasers.
Other devices such as Digital to Analog Converter (DAC)

Input/Output Devices may further comprise, but not be limited to, touchscreens, networking device (e.g., devices disclosed in network 562 sub-module), data storage device (non-volatile storage 561), facsimile (FAX), and graphics/sound cards.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “user” “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A system comprising:
a processor configured to:
acquire, over a network, user data from an entity;
analyze the user data by performing a computational analysis on the user data, and determine, based on the computational analysis, a plurality of features;
search, over the network, a local users database based on a query comprising the plurality of features, the search causing electronic retrieval of local historical users-related data that corresponds to the plurality of features;
generate at least one feature vector based on the plurality of features and the local historical users-related data;
execute an artificial intelligence/machine learning (AI/ML) model, the execution comprising providing the at least one feature vector as input to the AI/ML model, such that a predictive model is generated, the predictive model producing at least one lending parameter; and
output, based on execution of the AI/ML model via the predictive model, a data structure comprising information related to a user-related lending verdict, the data structure being executable so as to effectuate a secure transfer of digital assets to an electronic account of the user.

2. The system of claim 1, wherein the processor is further configured to:
receive user call data from a chat bot associated with the at least on lender entity node, the call data comprising data generated during user's communication with the chat bot;
derive a language metadata from the call data; and
parse the call data based on the language metadata to derive a plurality of key features.

3. The system of claim 2, wherein the processor is further configured to retrieve remote historical users′-related data from at least one remote users' database based on the local historical users′-related data, wherein the remote historical users′-related data is collected at locations associated with a plurality of lender entities affiliated with financial institutions.

4. The system of claim 3, wherein the processor is further configured to generate the at least one feature vector based on the plurality of features and the local historical users′-related data combined with the remote historical users′-related data and the plurality of key features.

5. The system of claim 4, wherein the processor is further configured to generate a user profile data based on the user data and the plurality of key features.

6. The system of claim 5, wherein the processor is further configured to periodically monitor the user profile data to determine if at least one value of the user profile data deviates from a value of previous user profile data by a margin exceeding a pre-set threshold value.

7. The system of claim 6, wherein the processor is further configured to, responsive to the at least one value of the user profile data deviating from the value of the previous user profile data by the margin exceeding the pre-set threshold value, generate an updated feature vector based on current user profile data and generate the lending verdict based on the at least one lending parameter produced by the predictive model in response to the updated feature vector.

8. The system of claim 7, wherein the processor is further configured to record the at least one lending parameter on a blockchain ledger along with the user profile data.

9. The system of claim 8, wherein the processor is further configured to wherein the instructions further cause the processor to retrieve the at least one lending parameter from the blockchain responsive to a consensus among the LS node and the at least one lender entity node.

10. The system of claim 8, wherein the processor is further configured to execute a smart contract to record data reflecting a loan approved for the user associated with the lending verdict and the at least one lender entity node on the blockchain for future audits.

11. A method comprising:
acquiring, by a device, over a network, user data from an entity;
analyzing, by the device, the user data by performing a computational analysis on the user data, and determine, based on the computational analysis, a plurality of features;
searching, by the device, over the network, a local users' database based on a query comprising the plurality of features, the search causing electronic retrieval of local historical users′-related data that corresponds to the plurality of features;
generating, by the device, at least one feature vector based on the plurality of features and the local historical users′-related data;
executing, by the device, an artificial intelligence/machine learning (AI/ML) model, the execution comprising providing the at least one feature vector as input to the AI/ML model, such that a predictive model is generated, the predictive model producing at least one lending parameter; and
outputting, by the device, based on execution of the AI/ML model via the predictive model, a data structure comprising information related to a user-related lending verdict, the data structure being executable so as to effectuate a secure transfer of digital assets to an electronic account of the user.

12. The method of claim 11, further comprising:
receiving user call data from a chat bot associated with the at least on lender entity node, the call data comprising data generated during user's communication with the chat bot;
deriving a language metadata from the call data; and
parsing the call data based on the language metadata to derive a plurality of key features.

13. The method of claim 12, further comprising retrieving remote historical users′-related data from at least one remote users' database based on the local historical users′-related data, wherein the remote historical users′-related data is collected at locations associated with a plurality of lender entities affiliated with financial institutions.

14. The method of claim 13, further comprising generating the at least one feature vector based on the plurality of features and the local historical users′-related data combined with the remote historical users′-related data and the plurality of key features.

15. The method of claim 14, further comprising generating a user profile data based on the user data and the plurality of key features and periodically monitoring the user profile data to determine if at least one value of the user profile data deviates from a value of previous user profile data by a margin exceeding a pre-set threshold value.

16. The method of claim 15, further comprising, responsive to the at least one value of the user profile data deviating from the value of the previous user profile data by the margin exceeding the pre-set threshold value, generating an updated feature vector based on current user profile data and generating the lending verdict based on the at least one lending parameter produced by the predictive model in response to the updated feature vector.

17. A non-transitory computer-readable medium tangibly encoded with computer-executable instructions, that when executed by a processor of a device, perform a method comprising:
acquiring, by the device, over a network, user data from an entity;
analyzing, by the device, the user data by performing a computational analysis on the user data, and determine, based on the computational analysis, a plurality of features;
searching, by the device, over the network, a local users' database based on a query comprising the plurality of features, the search causing electronic retrieval of local historical users′-related data that corresponds to the plurality of features;
generating, by the device, at least one feature vector based on the plurality of features and the local historical users′-related data;
executing, by the device, an artificial intelligence/machine learning (AI/ML) model, the execution comprising providing the at least one feature vector as input to the AI/ML model, such that a predictive model is generated, the predictive model producing at least one lending parameter; and
outputting, by the device, based on execution of the AI/ML model via the predictive model, a data structure comprising information related to a user-related lending verdict, the data structure being executable so as to effectuate a secure transfer of digital assets to an electronic account of the user.

18. The non-transitory computer readable medium of claim 17, further comprising instructions, that when read by the processor, cause the processor of the device to record the at least one lending parameter on a blockchain ledger along with a user profile data.

19. The non-transitory computer readable medium of claim 18, further comprising instructions, that when executed by the processor of the device, cause the processor to retrieve the at least one lending parameter from the blockchain responsive to a consensus among the LS node and the at least one lender entity node.

20. The non-transitory computer readable medium of claim 18, further comprising instructions, that when executed by the processor of the device, cause the processor to execute a smart contract to record data reflecting a loan approved for the user associated with the lending verdict and the at least one lender entity node on the blockchain for future audits.
